(19) United States
(12) Patent Application Publication
(10) Pub. No.: US 2006/0062423 A1
(43) Pub. Date: Mar. 23, 2006

(54) Speaker diaphragm and method of forming the same

(76) Inventors: Kazuharu Kawata, Yamagata (JP); Hideo Sekikawa, Yamagata (JP); Toshihiro Ishigaki, Yamagata (JP)

Correspondence Address: ARENT FOX PLLC, 1050 CONNECTICUT AVENUE, N.W., SUITE 400, WASHINGTON, DC, 20036, US

(21) Appl. No.: 11/229,833

(22) Filed: Sep. 20, 2005

(30) Foreign Application Priority Data
Sep. 22, 2004 (JP) 2004-275513

(51) Int. Cl. H04R 11/02

(52) U.S. Cl. 381/426; 381/424

(57) ABSTRACT

It is an object of the present invention to ensure that when a speaker diaphragm having an adequate fire resistance is to be obtained, it is possible to ensure stability of various characteristics and thus avoid a deterioration of an audio characteristic of the speaker device. An expansive graphite is mixed/milled with at least one of a natural fiber, a chemical fiber, an inorganic fiber, a synthetic fiber and the like consisting of different fibers selected from the foregoing fibers (step of mixing/milling a fiber with an expansive graphite), thereby obtaining a paper slurry. The paper slurry is adjusted and heated at an adequate molding temperature necessary for the expansive graphite to expand, thereby effecting milling and molding (milling/molding step) and thus obtaining a milled material serving as a diaphragm substrate having a fire resistant layer formed by a heated expansion of the expanding agent. The diaphragm substrate is then dipped in a liquid containing a fire resistant component (step of dipping the diaphragm substrate in a liquid containing a fire resistant component), followed by a drying step (drying the diaphragm substrate) and a finishing step (cutting the diaphragm substrate in accordance with desired inner and outer diameters), thereby obtaining a desired speaker diaphragm having a sufficient fire resistance.

### BACKGROUND OF THE INVENTION

The present invention relates to a speaker diaphragm and a method of forming the same.

The present application claims priority from Japanese Application No. 2004-275513, the disclosure of which is incorporated herein by reference.

A material for forming a speaker diaphragm is usually selected in order to obtain various characteristics corresponding to desired playback frequency bands. Further, it is also necessary for a speaker diaphragm to have an environment durability in response to an actual environment in which a speaker device is located. Particularly, with regard to a speaker device which is set in an environment such as an automobile vehicle in which fire prevention measure is required, it is necessary for a speaker diaphragm to have a fire resistance. In fact, some sorts of fire resistant diaphragms have already been disclosed in Japanese Unexamined Patent Application Publication No. 58-1397 and Japanese Examined Patent Application Publication No. 60-12840 both of which serve as prior arts in the present application.

In detail, Japanese Unexamined Patent Application Publication No. 58-1397 discloses a speaker diaphragm which is fire resistant and provides an acceptable sound quality, formed by using a dipping process, a spraying process or the like to impregnate an organic compound cone (containing phosphorus, nitrogen and mixed with a low-fluorine melamine resin) with an impregnating liquid covering at least one portion of the cone made mainly of cellulose fiber, followed by drying the impregnated cone. Moreover, Japanese Examined Patent Application Publication No. 60-12840 discloses a fire resistant diaphragm formed by mixing an inorganic fiber such as metal fiber, carbon fiber and glass fiber in a phosphoric acid system cellulose fiber or a phosphoric acid system polyvinyl alcohol fiber.

However, as disclosed in Japanese Unexamined Patent Application Publication No. 58-1397, if a diaphragm material is impregnated with a fire resisting agent by virtue of spraying or dipping, it will be difficult to constantly ensure an acceptable quality due to an influence of a concentration and an amount of the fire resisting agent. Further, since most fire resisting agents are of moisture absorptive, a vibration characteristic of a diaphragm will change with the passing of time due to an influence of moisture contained in air. As a result, a vehicle speaker device will suffer more from this problem since the interior of an automobile vehicle is mostly humid.

On the other hand, as disclosed in Japanese Examined Patent Application Publication No. 60-12840, if a fire resistant diaphragm is formed by mixing/milling an inorganic fiber such as metal fiber, carbon fiber and glass fiber in a phosphoric acid system cellulose fiber or a phosphoric acid system polyvinyl alcohol fiber, although it is possible to obtain an adequate fire resistance or an adequate heat durability and provide a speaker diaphragm having an acceptable stability owing to an improved moisture absorbability, it is still difficult to ensure sufficient physical properties such as Young's modulus, thus rendering it impossible for a speaker to provide an acceptable sound quality.

### SUMMARY OF THE INVENTION

The present invention has been accomplished in order to solve the aforementioned problem and it is an object of the present invention to ensure that when a speaker diaphragm having an adequate fire resistance is to be obtained, it is possible to make various characteristics stable and thus avoid a deterioration of an acoustic characteristic of speaker device.

To achieve the foregoing object, a speaker diaphragm and a method of forming the same according to the present invention, have at least the following features in the following aspects.

According to one aspect of the present invention, there is provided a speaker diaphragm having a fire resistance, which comprises a diaphragm substrate having a fire resistant layer formed by mixing/milling an expanding agent with at least one of a natural fiber, a chemical fiber, an inorganic fiber, a synthetic fiber and the like consisting of different fibers selected from said fibers, followed by a heated expansion of the expanding agent. In particular, the diaphragm substrate contains a fire resistant component having a low moisture absorbability.

According to another aspect of the present invention, there is provided a method of forming a speaker diaphragm having a fire resistance, comprising the steps of: forming a diaphragm substrate having a fire resistant layer by mixing/milling an expanding agent with at least one of a natural fiber, a chemical fiber, an inorganic fiber, a synthetic fiber and the like consisting of different fibers selected from said fibers, followed by a heated expansion of the expanding agent; and dipping the diaphragm substrate in a solution or a liquid material serving as a fire resistant component mainly containing triphenyl phosphate (TPP).

According to a further aspect of the present invention, there is provided a method of forming a speaker diaphragm having a fire resistance, comprising the steps of: forming a diaphragm substrate having a fire resistant layer by mixing/milling an expanding agent with at least one of a natural fiber, a chemical fiber, an inorganic fiber, a synthetic fiber and the like consisting of different fibers selected from said fibers, followed by a heated expansion of the expanding agent; and forming an application liquid containing a fire resistant component which mainly contains triphenyl phosphate (TPP), and applying the application liquid to the diaphragm substrate.

According to a still further aspect of the present invention, there is provided a method of forming a speaker diaphragm having a fire resistance, wherein when mixing/milling an expanding agent with at least one of a natural fiber, a chemical fiber, an inorganic fiber, a synthetic fiber and the like consisting of different fibers selected from said fibers, a fire resistant component which mainly contains triphenyl phosphate (TPP) is also mixed therein, followed by a heated expansion of the expanding agent, thereby forming a diaphragm substrate having a fire resistant layer.

### BRIEF DESCRIPTION OF THE DRAWINGS

These and other objects and advantages of the present invention will become clear from the following description with reference to the accompanying drawings, wherein:

FIG. 1 is a flow chart showing a method of forming a speaker diaphragm according to a first embodiment of the present invention;

FIG. 2 is a flow chart showing a method of forming a speaker diaphragm according to a second embodiment of the present invention; and

FIG. 3 is a flow chart showing a method of forming a speaker diaphragm according to a third embodiment of the present invention.

### DETAILED DESCRIPTION OF THE PREFERRED EMBODIMENTS

Next, preferred embodiments of the present invention will be described with reference to the accompanying drawings. In fact, a speaker diaphragm formed according to the present invention has a fire resistance, various stabilized characteristics and thus can avoid a deterioration of an acoustic characteristic of a speaker device. In detail, the speaker diaphragm comprises a diaphragm substrate having a fire resistant layer formed by mixing/milling an expanding agent with a natural fiber, a chemical fiber, an inorganic fiber, or a synthetic fiber or the like consisting of different fibers selected from said fibers, followed by a heated expansion of the expanding agent. Specifically, the diaphragm substrate contains a fire resistant component having a low moisture absorbability.

In more detail, the expanding agent may be, for example, an expansive graphite formed by intercalating chemical substance in graphite, and such expansive graphite is mixed/milled with a fiber so as to form a slurry mixture which is then heated to effect milling and molding, thereby obtaining a diaphragm substrate containing a fire-resistant layer formed by a heated expansion of the expansive graphite. Such a diaphragm substrate having such a fire-resistant layer makes it possible to obtain some desired physical characteristics such as an appropriate Young's modulus suitable for a speaker diaphragm. On the other hand, since it is impossible to obtain an adequate fire resistance only by the diaphragm substrate based on such milled material, it is necessary to add a fire resistant component mainly containing triphenyl phosphate (TPP) so as to ensure a necessary fire resistance. Further, if such a fire resistant component is a substance having a low moisture absorbability, it is possible to prevent a degradation of physical characteristic and a deterioration of acoustic characteristic of the speaker device, which would otherwise occur with the passing of time. In this way, since triphenyl phosphate (TPP) is added to perform a fire-resisting treatment on the diaphragm substrate having the fire resistant layer formed by a heated expansion of an expansive graphite, it becomes possible not only to improve a fire resistance, but also to improve an acoustic physical characteristic. Therefore, it is possible to obtain an improved speaker diaphragm having an adequate fire resistance, an acceptable acoustic characteristic and an improved stability even under a humid condition.

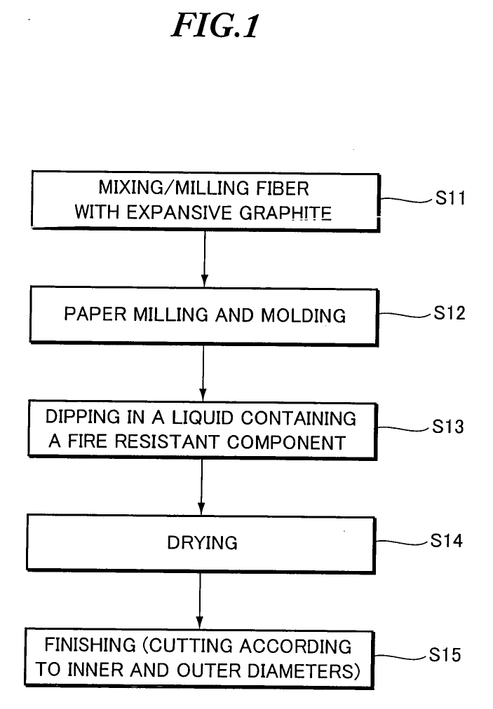

Next, description will be given in detail to explain a method of forming a speaker diaphragm according to several embodiments of the present invention, with reference to FIGS. 1 to 3.

FIG. 1 is a flowchart showing a first embodiment of the present invention. As shown, an expansive graphite is mixed/milled with a natural fiber, a chemical fiber, an inorganic fiber, or a synthetic fiber or the like consisting of different fibers selected from the foregoing fibers (S11: step of mixing/milling a fiber with an expansive graphite), thereby obtaining a paper slurry. The paper slurry is adjusted and heated at an adequate molding temperature necessary for the expansive graphite to expand, thereby effecting milling and molding (S12: milling/molding step) and thus obtaining a milled material serving as a diaphragm substrate having a fire resistant layer formed by a heated expansion of the expanding agent. The diaphragm substrate is then dipped in a liquid containing a fire resistant component (S13: step of dipping a diaphragm substrate in a liquid containing a fire resistant component), followed by a drying step (S14: drying the diaphragm substrate) and a finishing step (S15: cutting the diaphragm substrate in accordance with desired inner and outer diameters), thereby obtaining a desired speaker diaphragm having a sufficient fire resistance.

Here, as the liquid containing a fire resistant component, it is allowed to use a solution formed by dissolving TPP in a solvent (such as an organic solvent or the like), and it is also possible to use a liquid formed by heating TPP to its melting point and thus liquefying the same.

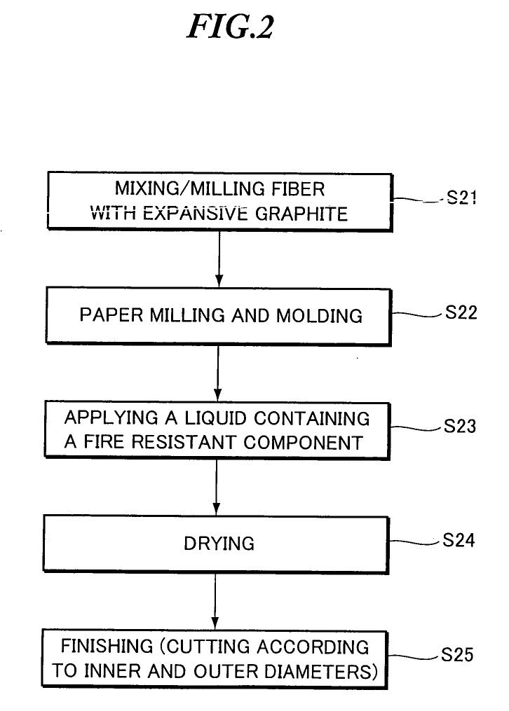

FIG. 2 is a flow chart showing a second embodiment of the present invention. As shown, an expansive graphite is mixed/milled with a natural fiber, a chemical fiber, an inorganic fiber, or a synthetic fiber or the like consisting of different fibers selected from the foregoing fibers (S21: step of mixing/milling a fiber with an expansive graphite), thereby obtaining a paper slurry. The paper slurry is adjusted and heated at an adequate molding temperature necessary for the expansive graphite to expand, thereby effecting milling and molding (S22: milling/molding step) and thus obtaining a milled material serving as a diaphragm substrate having a fire resistant layer formed by a heated expansion of the expanding agent. Then, a liquid containing a fire resistant component is applied to the diaphragm substrate (S23: step of applying a liquid containing a fire resistant component), followed by a drying step (S24: drying the diaphragm substrate) and a finishing step (S25: cutting the diaphragm substrate in accordance with desired inner and outer diameters), thereby obtaining a desired speaker diaphragm having a sufficient fire resistance.

Similar to the above, as the liquid containing a fire resistant component, it is allowed to use a solution formed by dissolving TPP in a solvent (such as an organic solvent or the like), and it is also possible to use a liquid formed by heating TPP to its melting point and thus liquefying the same. The obtained solution or liquid is applied to the diaphragm substrate by means of spraying. Alternatively, TPP may be crushed into powder which is then mixed with a resin having a binding force or an adhesion power, or mixed with an inorganic substance such as cement or the like. The obtained mixture is then applied to the diaphragm substrate.

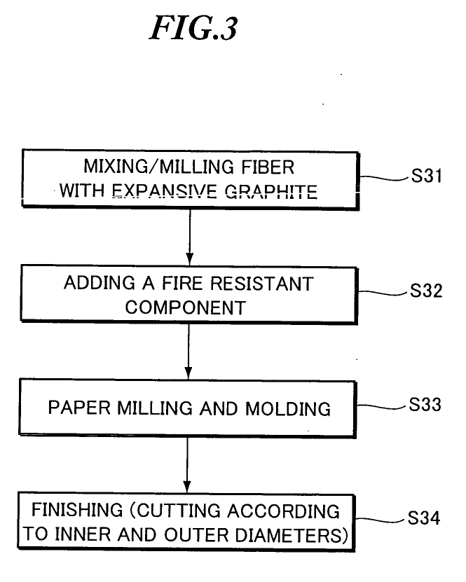

FIG. 3 is a flow chart showing a third embodiment of the present invention. As shown, an expansive graphite is mixed/milled with a natural fiber, a chemical fiber, an inorganic fiber, or a synthetic fiber or the like consisting of different fibers selected from the foregoing fibers (S31: step of mixing/milling a fiber with an expansive graphite), thereby obtaining a paper slurry. Then, a fire resistant component is mixed into the paper slurry (S32: adding a fire resistant component). At this time, such a fire resistant component may be a powder formed by crushing solid TPP, and dispersed in the paper slurry, thereby ensuring a uniform mixing of the fire resistant component. Subsequently, the paper slurry mixed with the fire resistant component is heated, followed by milling and molding (S33), thereby obtaining a diaphragm substrate having a fire resistant layer formed by a heated expansion of the expanding agent. Afterwards, a finishing step (S34: cutting the diaphragm substrate in accordance with desired inner and outer diameters) is carried out, thereby obtaining a desired speaker diaphragm having a sufficient fire resistance.

### EXAMPLES

Next, description will be given to explain some further detailed examples of a speaker diaphragm and a method of forming the same, according to the present invention. Here, the method of forming the speaker diaphragm is carried out in accordance with the above-described first embodiment, using materials listed in the following Table 1.

TABLE 1

| | | EXAMPLE 1 | | EXAMPLE 2 | | EXAMPLE 3 | |
|---|---|---|---|---|---|---|---|
| | | MATERIAL | RATE | MATERIAL | RATE | MATERIAL | RATE |
| MILLING | FIBER | WOOD PULP | 90 | WOOD PULP | 70 | WOOD PULP | 80 PARTS |
| | | | PARTS | | PARTS | | BY |
| | | | BY | | BY | | WEIGHT |
| | | | WEIGHT | | WEIGHT | | |
| | EXPANDING | EXPANSIVE | 10 | EXPANSIVE | 30 | ARAMID | 10 PARTS |
| | AGENT | GRAPHITE | PARTS | GRAPHITE | PARTS | FIBER | BY |
| | | | BY | | BY | | WEIGHT |
| | | | WEIGHT | | WEIGHT | | |
| | | — | — | — | — | EXPANSIVE | 10 PARTS |
| | | | | | | GRAPHITE | BY |
| | | | | | | | WEIGHT |
| IMPREGNATING | FIRE | TPP | 30 | TPP | 30 | TPP | 20 PARTS |
| LIQUID | RESISTANT | | PARTS | | PARTS | | BY |
| | COMPONENT | | BY | | BY | | WEIGHT |
| | | | WEIGHT | | WEIGHT | | |
| | SOLVENT | MIXED | 70 | MIXED | 70 | MIXED | 80 PARTS |
| | | SOLVENT | PARTS | SOLVENT | PARTS | SOLVENT | BY |
| | | | BY | | BY | | WEIGHT |
| | | | WEIGHT | | WEIGHT | | |

### Example 1

In the milling process, 90 parts by weight of wood pulp (needle-leaf tree kraft pulp) serving as a fiber and 10 parts by weight of an expansive graphite serving as an expanding agent are mixed/milled together to form a paper slurry. This is only an example of fiber mixing and mixing/milling of a fire resistant fiber or an incombustible fiber makes it possible to improve fire resistance. Here, the expansive graphite mixed has a particle size of 50 meshes or more which is suitable for paper making.

In the impregnating and drying steps, a liquid containing a fire resistant component is formed by mixing 30 parts by weight of triphenyl phosphate and 70 parts by weight of a mixed solvent consisting of aromatic hydrocarbons. Then, a milled/molded diaphragm substrate is uniformly and sufficiently impregnated with the liquid containing the fire resistant component, followed by carrying out a hot-air drying (for example, the drying process is performed in an atmosphere of 80° C. for 10 minutes), thereby obtaining a speaker diaphragm having a desired fire resistance.

### Example 2

Example 2 is carried out in almost the same process as Example 1 except that the mixing rates of wood pulp and expansive graphite in the paper milling process (wood pulp: 70 parts by weight; expansive graphite: 30 parts by weight) are different from those used in Example 1.

### Example 3

In a milling process similar to Example 1, 80 parts by weight of wood pulp (needle-leaf tree kraft pulp) serving as a fiber, 10 parts by weight of aramid fiber having a fiber length of 3 mm and 10 parts by weight of an expansive graphite serving as an expanding agent are mixed/milled together to form a paper slurry. In this way, using aramid fiber can improve fire resistance of speaker diaphragm and increase the thickness of milled paper material, making it possible to effectively absorb TPP during a resin impregnating process. Further, in this example, in order to ensure an appropriate adhesion amount, an impregnating liquid is formed by 20 parts by weight of TPP and 80 parts by weight of mixed solvent. After impregnation using liquid containing fire resistant component in a process similar to that in Example 1, a drying process is performed using a hot air.

### Evaluation of Examples

The above-described Examples (Examples 1, 2, 3) of the present invention were compared with Comparative Examples (speaker diaphragms consisting of milled materials not treated in any fire resisting treatment based on TPP) so as to perform a comparison among the physical properties of diaphragms obtained in the above Examples and Comparative Examples. The comparison results are listed in the following Table 2. As a result, it was confirmed that the fire resisting treatment based on TPP is effective not only for improving a fire resistance, but also for improving an acoustic physical characteristic.

TABLE 2

| | | | YOUNG'S | INTERNAL | SOUND |
|---|---|---|---|---|---|
| | | DENSITY | MODULES | LOSS | SPEED |
| | SPECIMEN | [kg/m³] | [×10⁹ N/m²] | [×10⁻²] | [m/sec.] |
| EXAMPLES | EXAMPLE 1 | 918 | 8.0 | 2.3 | 2960 |
| | EXAMPLE 2 | 891 | 8.2 | 2.3 | 3030 |
| | EXAMPLE 3 | 566 | 2.3 | 5.9 | 2100 |
| COMPARATIVE | COMPARATIVE | 716 | 5.4 | 2.4 | 2730 |
| EXAMPLES | EXAMPLE 1 | | | | |
| | COMPARATIVE | 716 | 5.6 | 2.4 | 2710 |
| | EXAMPLE 2 | | | | |
| | COMPARATIVE | 501 | 2.0 | 5.8 | 1980 |
| | EXAMPLE 2 | | | | |

Note:
Comparative Example 1: single piece of paper milling product of Example 1 (not treated in fire resisting treatment based on TPP)
Comparative Example 2: single piece of paper milling product of Example 2 (not treated in fire resisting treatment based on TPP)
Comparative Example 3: single piece of paper milling product of Example 3 (not treated in fire resisting treatment based on TPP)

On the other hand, combustion test was conducted on each of the specimens listed in each of the above Tables in order to confirm the fire resistance of each product obtained in each of the Examples 1, 2 and 3 of the present invention. As a result, it was confirmed that after a test fire is removed, each of the specimens in each of the Comparative Examples 1, 2 and 3 continued to burn, while each of the specimens in each of the Examples 1, 2 and 3 had no remaining fire due to carbonization and self-digestion, thereby conforming that the present invention can provide an excellent fire resistance corresponding to UL standard 94-V-0˜V-1. Here, since TPP which is contained as a fire resistant component has a low moisture absorbability, a speaker diaphragm having a fire resistant layer containing TPP is stable in its various characteristics even if it is being used in a highly humid environment and no remarkable deterioration was found in the acoustic characteristic of a speaker device containing such speaker diaphragm.

As described above, using a speaker diaphragm and a method of forming the same according to the above embodiments or the above examples of the present invention, if the speaker diaphragm has an adequate fire resistance, it is possible for the speaker diaphragm to be stable in its various properties and a speaker device containing such a speaker diaphragm can avoid a deterioration of its acoustic characteristic, thereby ensuring an acceptable acoustic characteristic.

As described above, an expansive graphite is mixed/milled with a natural fiber, a chemical fiber, an inorganic fiber, or a synthetic fiber or the like consisting of different fibers selected from the foregoing fibers, for the purpose of obtaining a diaphragm substrate having a fire resistant layer formed by a heated expansion of the expansive graphite. Since such diaphragm substrate contains triphenyl phosphate (TPP) which is a fire resistant component having a low moisture absorbability, it is possible to ensure an adequate fire resistance by performing a fire resisting treatment using TPP on the diaphragm substrate having the fire resistant layer. Moreover, by performing a fire resisting treatment using TPP on the diaphragm substrate having the fire resistant layer formed by virtue of an expansion of the expansive graphite, it is possible to improve not only a fire resistance but also an acoustic physical performance of the speaker diaphragm. In addition, since TPP has a low moisture absorbability, it provides an advantage that a deterioration of an acoustic characteristic due to an absorbed moisture is not likely to occur even if the speaker device is used in a highly humid environment.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A speaker diaphragm having a fire resistance, comprising:
a diaphragm substrate having a fire resistant layer formed by mixing/milling an expanding agent with at least one of a natural fiber, a chemical fiber, an inorganic fiber, a synthetic fiber and the like consisting of different fibers selected from said fibers, followed by a heated expansion of the expanding agent,
wherein the diaphragm substrate contains a fire resistant component having a low moisture absorbability.

2. The speaker diaphragm according to claim 1, wherein said expanding agent is an expansive graphite, and said fire resistant component mainly contains triphenyl phosphate (TPP).

3. A method of forming a speaker diaphragm having a fire resistance, comprising the steps of:
forming a diaphragm substrate having a fire resistant layer by mixing/milling an expanding agent with at least one of a natural fiber, a chemical fiber, an inorganic fiber, a synthetic fiber and the like consisting of different fibers selected from said fibers, followed by a heated expansion of the expanding agent; and
dipping the diaphragm substrate in a solution or a liquid material serving as a fire resistant component mainly containing triphenyl phosphate (TPP).

4. A method of forming a speaker diaphragm having a fire resistance, comprising the steps of:
forming a diaphragm substrate having a fire resistant layer by mixing/milling an expanding agent with at least one of a natural fiber, a chemical fiber, an inorganic fiber, a synthetic fiber and the like consisting of different fibers selected from said fibers, followed by a heated expansion of the expanding agent; and
forming an application liquid containing a fire resistant component which mainly contains triphenyl phosphate (TPP), and applying the application liquid to the diaphragm substrate.

5. A method of forming a speaker diaphragm having a fire resistance, wherein when mixing/milling an expanding agent with at least one of a natural fiber, a chemical fiber, an inorganic fiber, a synthetic fiber and the like consisting of different fibers selected from said fibers, a fire resistant component which mainly contains triphenyl phosphate (TPP) is also mixed therein, followed by a heated expansion of the expanding agent, thereby forming a diaphragm substrate having a fire resistant layer.
